(19) United States
(12) Patent Application Publication
(10) Pub. No.: US 2025/0341640 A1
(43) Pub. Date: Nov. 6, 2025

(54) SYSTEMS AND METHODS FOR CROSS-CORRELATION DETECTION

(71) Applicant: Samsung Electronics Co., Ltd., Suwon-si (KR)

(72) Inventors: Jie Wu, San Diego, CA (US); Xiaojia Liu, Marion, IA (US); Sigang Qiu, Sunnyvale, CA (US); William Higgins, Cedar Rapids, IA (US); Gary Lennen, Cupertino, CA (US)

(21) Appl. No.: 18/919,114

(22) Filed: Oct. 17, 2024

Related U.S. Application Data
(60) Provisional application No. 63/643,314, filed on May 6, 2024.

(51) Int. Cl. G01S 19/21; G01S 19/29; G01S 19/30

(52) U.S. Cl. CPC G01S 19/21; G01S 19/29; G01S 19/30

(57) ABSTRACT

A system and a method are disclosed for cross-correlation detection. The method includes receiving, by a receiver, a first signal of a first satellite and a second signal of the first satellite, selecting, by the receiver, the first signal to be a tracked signal, selecting, by the receiver, the second signal to be an untracked signal, tracking, by the receiver, the first signal, generating, by the receiver, a first measurement based on the tracking of the first signal, determining, by the receiver, a second measurement of the second signal based on the first measurement, and performing an operation on the receiver based on the second measurement.

### CROSS-REFERENCE TO RELATED APPLICATION

This application claims the priority benefit under 35 U.S.C. § 119(e) of U.S. Provisional Application No. 63/643,314, filed on May 6, 2024, the disclosure of which is incorporated by reference in its entirety as if fully set forth herein.

### TECHNICAL FIELD

The disclosure generally relates to communications systems. More particularly, the subject matter disclosed herein relates to improvements to tracking with a global navigation satellite system (GNSS) receiver.

### SUMMARY

A satellite system (e.g., a GNSS) may include a plurality of satellites. Each satellite may broadcast one or more signals, which may be received by a receiver (e.g., a GNSS receiver) to allow the receiver to determine its geographic location and to perform operations on the receiver based on the geographic location. The receiver may receive and track signals from more than one satellite to determine its geographic location. The signals broadcast by each satellite may comprise a pseudorandom noise (PRN) code. The PRN code of a first satellite may be a different code than the PRN code of a second satellite. The receiver may generate local versions of the PRN codes for different satellites to identify matches (i.e., to identify correlations) between received PRN codes and locally generated PRN codes.

Some satellite systems may include some satellites that broadcast more than one signal from the same satellite. For example, in the BeiDou satellite system (BDS), some satellites may broadcast both B1I and B1C signals. In the Global Positioning System (GPS) satellite system, some satellites may broadcast both L1 and L2 signals. Although the present disclosure refers mostly to B1I and B1C signals, one of ordinary skill in the art would understand that the present disclosure may be applied to any suitable satellite system that includes a satellite capable of broadcasting more than one signal.

To limit the number of the total required tracking channels and to reduce power consumption, a receiver may choose to track some, but not all, of the signals from a satellite for certain applications or devices. For example, a GNSS receiver may track only one of the B1I or B1C signals transmitted from the same satellite. Tracking only one of the signals from a satellite may lead to cross-correlation issues, wherein energy from an untracked signal may cause the receiver to determine erroneously that it is receiving a signal from a different satellite. Relying on such an erroneous determination may significantly degrade the accuracy of the receiver in determining its geographic location. Cross-correlation detection may allow a receiver to determine whether the untracked signal from a first satellite is the actual source of energy, which may otherwise erroneously appear as corresponding to energy from a second satellite. Thus, cross-correlation errors may be reduced (e.g., may be prevented) based on cross-correlation detection.

To overcome cross-correlation issues, systems and methods are described herein for cross-correlation detection in satellite systems that include a satellite that broadcasts more than one signal (e.g., a first signal and a second signal), wherein a cross-correlation source may be detected by: (i) tracking both the first signal and the second signal at the same time in separate channels; (ii) tracking the first signal and the second signal in a time-sharing fashion in a same tracking channel; (iii) tracking only the first signal and deriving measurements for the second signal based on measurements from the first signal; (iv) tracking both signals at different times, by switching from briefly tracking the second signal to tracking the first signal for a longer period of time; and (v) fully tracking only the first signal while only sampling the peak signal strength of the second signal and deriving measurements for the second signal based on measurements from the first signal.

The above approaches improve on previous methods because false alarms (e.g., ghost signals) caused by cross-correlation issues may be detected and reduced (e.g., prevented). Aspects of some embodiments of the present disclosure allow for a number of tracking channels and/or an amount of power consumption to be reduced.

According to some embodiments of the present disclosure, a method for cross-correlation detection includes receiving, by a receiver, a first signal of a first satellite and a second signal of the first satellite, selecting, by the receiver, the first signal to be a tracked signal, selecting, by the receiver, the second signal to be an untracked signal, tracking, by the receiver, the first signal, generating, by the receiver, a first measurement based on the tracking of the first signal, determining, by the receiver, a second measurement of the second signal based on the first measurement, and performing an operation on the receiver based on the second measurement.

The tracking the first signal may include tracking, by the receiver, a carrier of the first signal and tracking, by the receiver, a code of the tracked signal, and being untracked may include not tracking, by the receiver, a carrier of the untracked signal and/or not tracking, by the receiver, a code of the untracked signal.

The carrier may include at least one of a signal carrier frequency or a signal carrier phase.

The operation may include determining that the second signal is a cross-correlation source associated with a detection associated with a second satellite.

The operation may include determining, by the receiver, a geographic location of the receiver.

The determining the second measurement may include calculating a result of an equation including the first measurement and a constant value.

The constant value may include a first power delta value measured with respect to the first satellite.

The first power delta value may be received from a memory of the receiver, the memory storing the first power delta value and storing a second power delta value measured with respect to a second satellite.

The first power delta value may be received from a server that is communicatively coupled to the receiver.

The determining the second measurement may include selecting the second signal to be a tracked signal, performing tracking on the second signal and determining a calibration measurement associated with the second signal, and determining the second measurement based on the first measurement of the first signal and based on the calibration measurement.

The determining the second measurement may include receiving a sample corresponding to the second signal, and determining a location of a peak signal strength of the second signal based on the tracking the first signal, the location being associated with a signal frequency and a signal code phase of the first signal.

The N correlators may cooperate to perform the tracking the first signal, N being an integer greater than one, M correlators may cooperate to perform the determining the second measurement, M being an integer greater than zero, and N may be greater than M.

The method may further include receiving, by a receiver, a third signal of a second satellite and a fourth signal of the second satellite, and either selecting, by the receiver, both the third signal and the fourth signal to be tracked signals, or tracking the third signal and the fourth signal in a time-sharing fashion.

According to other embodiments of the present disclosure, a device includes a processing circuit, and a receiver communicatively coupled to the processing circuit, wherein the receiver is configured to perform receiving a first signal of a first satellite and a second signal of the first satellite, selecting the first signal to be a tracked signal, selecting the second signal to be an untracked signal, tracking the first signal, generating a first measurement based on the tracking of the first signal, determining a second measurement of the second signal based on the first measurement, and an operation based on the second measurement.

The determining the second measurement may include calculating a result of an equation including the first measurement and a constant value.

The constant value may include a first power delta value measured with respect to the first satellite.

The determining the second measurement may include selecting the second signal to be a tracked signal, performing tracking on the second signal and determining a calibration measurement associated with the second signal, and determining the second measurement based on the first measurement of the first signal and based on the calibration measurement.

The determining the second measurement may include receiving a sample corresponding to the second signal, and determining a location of a peak signal strength of the second signal based on the tracking the first signal, the location being associated with a signal frequency and a signal code phase of the first signal.

The N correlators may cooperate to perform the tracking the first signal, N being an integer greater than one, M correlators may cooperate to perform the determining the second measurement, M being an integer greater than zero, and N may be greater than M.

According to other embodiments of the present disclosure, a system includes a processing circuit, and a memory storing instructions that, when executed by the processing circuit, cause the processing circuit to perform receiving a first signal of a first satellite and a second signal of the first satellite, selecting the first signal to be a tracked signal, selecting the second signal to be an untracked signal, tracking the first signal, generating a first measurement based on the tracking of the first signal, determining a second measurement of the second signal based on the first measurement, and an operation based on the second measurement.

### BRIEF DESCRIPTION OF THE DRAWING

In the following section, the aspects of the subject matter disclosed herein will be described with reference to exemplary embodiments illustrated in the figures.

FIG. 1 is a block diagram depicting a system for cross-correlation detection, according to some embodiments of the present disclosure.

FIG. 2 is a diagram depicting signals transmitted from a plurality of satellites to a receiver, according to some embodiments of the present disclosure.

FIG. 3A and 3B (collectively, FIG. 3) are block diagrams depicting a first method for cross-correlation detection, according to some embodiments of the present disclosure.

FIG. 4 is a block diagram depicting a modification to the first method for cross- correlation detection, according to some embodiments of the present disclosure.

FIGS. 5A-5C (collectively, FIG. 5) are block diagrams depicting a second method for cross-correlation detection, according to some embodiments of the present disclosure.

FIGS. 6A is a block diagram depicting a third method for cross-correlation detection, according to some embodiments of the present disclosure.

FIG. 6B is a graph depicting a relationship between a peak of a tracked signal and a peak of an untracked signal utilized by the third method, according to some embodiments of the present disclosure.

FIG. 6C is a block diagram depicting components of a receiver for performing the third method, according to some embodiments of the present disclosure.

FIG. 7 is a block diagram of an electronic device in a network environment, according to some embodiments of the present disclosure.

FIG. 8 is a flowchart depicting operations of a method for cross-correlation detection, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

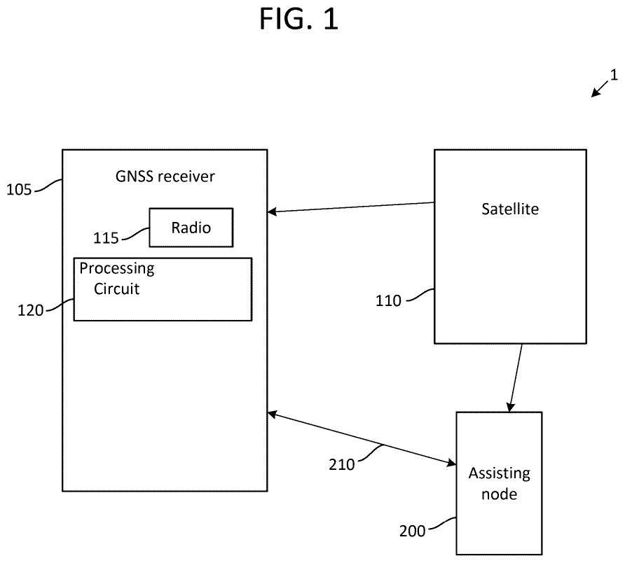

FIG. 1 is a block diagram depicting a system for cross-correlation detection, according to some embodiments of the present disclosure.

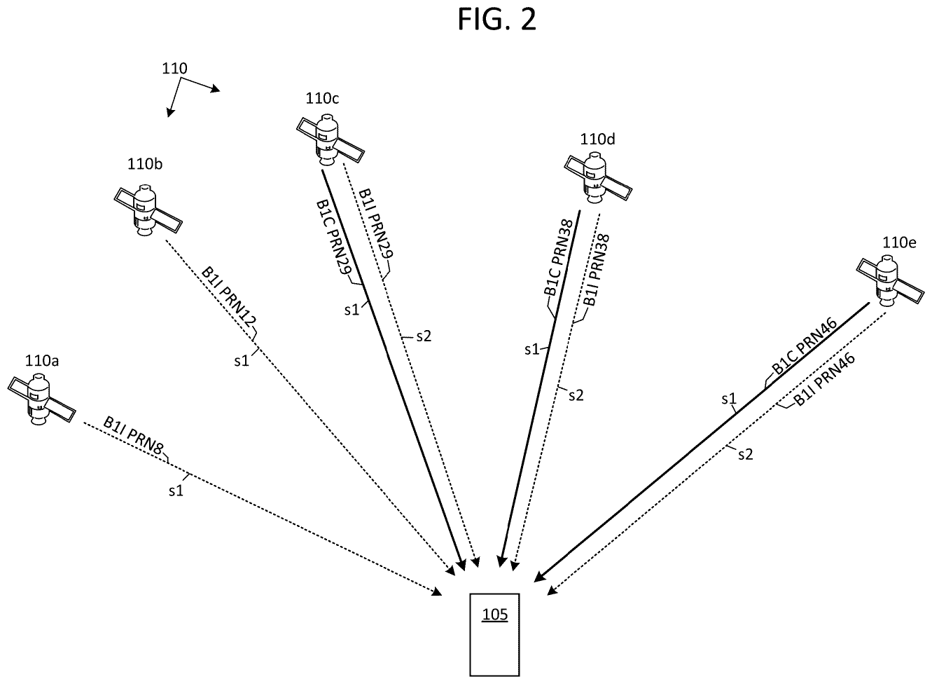

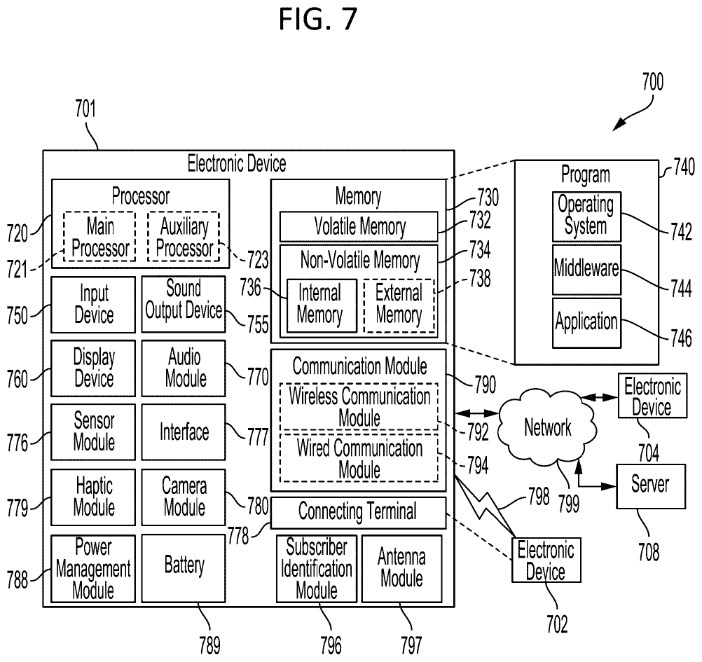

Referring to FIG. 1, a system I may include a receiver 105 and a satellite 110 (e.g., a satellite vehicle (SV)) communicatively coupled to each other. The receiver 105 may include a radio 115 and a processing circuit 120 (e.g., a means for processing), which may perform various methods disclosed herein, e.g., the methods illustrated with respect to FIGS. 2-6C and 8. For example, the processing circuit 120 may receive, via the radio 115, transmissions from the satellite 110, and the processing circuit 120 may transmit, via the radio 115, signals to other devices and/or to a base station. The receiver 105 may correspond to an electronic device 701 of FIG. 7. The processing circuit 120 may correspond to a processor 720 of FIG. 7.

In some embodiments, the system 1 may include an assisting node 200. The assisting node 200 may be a server or a reference receiver (e.g., a reference GNSS receiver). The assisting node 200 may be communicatively coupled to the receiver 105 by a communications link (e.g., an internet link such as Wireless Fidelity (Wi-Fi), a cellular modem, etc.).

FIG. 2 is a diagram depicting signals transmitted from a plurality of satellites to a receiver, according to some embodiments of the present disclosure.

Referring to FIG. 2, the receiver 105 may receive signals from a plurality of satellites 110. Each of the satellites 110 may broadcast a given PRN code. Some of the satellites 110 may broadcast (e.g., transmit) one signal (e.g., a first signal s1). Some of the satellites 110 may broadcast two signals (e.g., the first signal s1 and a second signal s2). For example, in BDS, satellite 110a may broadcast only B1I PRN8, satellite 110b may broadcast only B1I PRN12, satellite 110c may broadcast both B1C PRN29 and B1I PRN29, satellite 110d may broadcast both B1C PRN38 and B1I PRN38, and satellite 110e may broadcast both B1C PRN46 and B1I PRN46. For example, satellites that broadcast PRN numbers 1 to 16 may only broadcast B1I, satellites that broadcast PRN numbers 19 to 46 may broadcast both B1I and B1C, and satellites that broadcast PRN numbers 59 to 62 may only broadcast B1I.

The receiver 105 may track several signals to calculate the geographic position of the receiver 105. Because the satellites 110 send different PRN codes (e.g., PRN8, PRN12, PRN29, PRN38, and PRN46) to the receiver 105, cross-correlation issues may occur between the codes. As similarly discussed above, energy from one signal (e.g., B1I PRN29 of satellite 110c) may cause the receiver 105 to determine erroneously that it is receiving a signal (e.g., B1I PRN12) from a different satellite (e.g., satellite 110b). That is, the receiver 105 may erroneously generate a non-zero correlation with PRN12 due to B1I PRN29 behaving as a cross-correlation source.

In some embodiments, to reduce (e.g., to avoid) cross-correlation issues, the receiver 105 may track both signals (e.g., B1C PRN29 and B1I PRN29) from a given satellite (e.g., satellite 110c). Based on measurements associated with both signals from the same given satellite, the receiver 105 can detect cross-correlation and determine whether one of the tracked signals is a cross-correlation source, causing a ghost detection (e.g., an erroneous detection or erroneous measurement) of PRN12. Although tracking both signals continuously may allow for suitable cross-correlation detection, such tracking would occupy two tracking channels (e.g., would consume more hardware) and may consume significant power without providing an additional positioning benefit due to both channels being occupied by signals from one satellite. That is, tracking signals from different satellites may provide for better positioning accuracy and better reliability than tracking signals from one satellite. In some receivers, where there is a limited number of tracking channels, there may not be a sufficient number of tracking channels to support tracking more than one signal (e.g., tracking more than one signal at a time) from the same satellite.

In some embodiments, to reduce cross-correlation issues and to avoid occupying two tracking channels, the receiver 105 may track both signals (e.g., B1C PRN29 and B1I PRN29) from the same given satellite (e.g., satellite 110c) in a time-sharing fashion in a same tracking channel (e.g., switching back and forth between tracking the first signal s1 and tracking the second signal s2). Although tracking both signals in a time-sharing fashion may allow for suitable cross-correlation detection, such tracking may be complex while negatively impacting navigation performance and not allowing for carrier phase measurements.

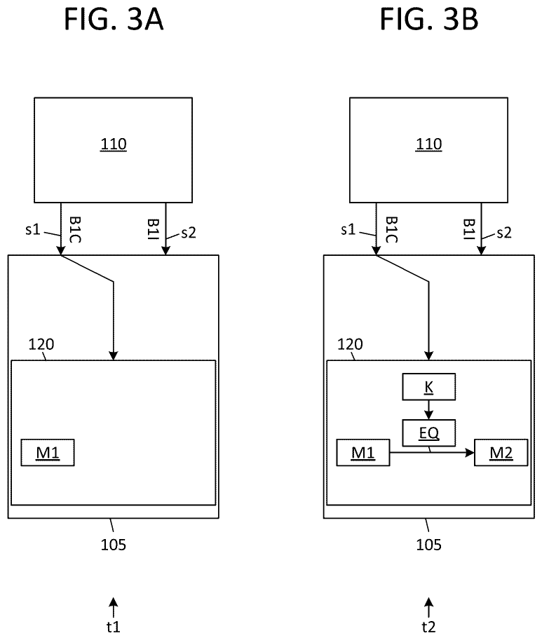

As discussed in further detail below with respect to FIGS. 3A-6C and 8, aspects of some embodiments of the present disclosure allow for cross-correlation detection from satellites that transmit more than one signal while reducing a number of tracking channels and/or reducing (e.g., minimizing) power consumption and improving positioning accuracy and reliability, which would otherwise might be degraded due to cross-correlation.

Referring still to FIG. 2, to save a number of tracking channels and to minimize power consumption, the receiver 105 may track only one of the two signals (B1C and B1I) for the same PRN from the same satellite 110. For example, in BDS, because B1C signals are newer (e.g., are based on a newer technology than B1I signals), have greater signal strengths, and have a pilot component, which may allow for improved sensitivity, the receiver 105 may choose to track only B1C signals for PRN numbers 19 to 46 (e.g., the PRN codes associated with satellites that generate two signals instead of one).

As discussed above, choosing to track only the B1C signals may cause an issue from a B1I cross-correlation perspective. For example, when the strong B1I signals of PRN numbers 19 to 46 are not tracked, they may not be included in a cross-correlation database for strong B1I SVs. Therefore, the cross-correlations from these strong B1I signals may sometimes be misdetected, resulting in false alarms.

For cross-correlation detection purposes, at least three methods may be used to derive a measurement of an untracked signal from a tracked signal of the same PRN to reduce a number of channels and corresponding hardware and to reduce power consumption while avoiding cross-correlation false alarms from the tracked signal. An untracked signal, as used herein, may also be referred as a “derived-measurement signal” when the receiver 105 derives or estimates measurements (e.g., characteristics) of the untracked signal based on measurements of a tracked signal. Because B1C and B1I signals for the same PRN number are generated by the same satellite, B1I measurements may be derived from B1C measurements, and vice versa. Although the present disclosure refers to deriving B1I measurements from B1C measurements, it should be understood that the present disclosure is not limited thereto. For example, aspects of some embodiments of the present disclosure may include deriving measurements of any suitable signal from the measurements of any other suitable signal when the two signals are transmitted by the same satellite.

In some embodiments, a first method (referred to herein as “Method 1: Constant-Value Derivation”) may provide for cross-correlation detection based on using a constant carrier-to-noise density-ratio (C/No) delta (e.g., a power delta, or a signal strength delta, representing a difference between two parameters) to perform the derivation between a tracked signal (e.g., a first signal s1 of the satellite 110c) and an untracked signal (e.g., a second signal s2 of the satellite 110c). As used herein, a signal that is at a point in time a “tracked signal” refers to a signal having both a carrier and a code (e.g., both a signal frequency and a code phase) that are tracked, at that point in time, by the receiver 105. As used herein, a signal that is at a point in time an “untracked signal” refers to a signal having at least one of a carrier or a code (e.g., at least one of a signal frequency or a code phase) that is not tracked, at that point in time, by the receiver 105.

In some embodiments, a second method (referred to herein as “Method 2: Calibration-Value Derivation”) may provide for cross-correlation detection based on tracking the untracked signal, only for a short period of time, to generate a calibration measurement that will be later used in the derivation. As used herein, a “calibration measurement” refers to an initial measurement associated with a signal, the initial measurement being used at a later time to derive, or approximate, a measurement associated with the signal for a given period of time after the initial measurement is made. For example, a calibration measurement may be a C/No delta calibration measurement, and the method may include: initially, tracking the untracked signal for a short period of time and obtaining the C/No measurement of the untracked signal; then, tracking the tracked signal and obtaining the C/No measurement of the tracked signal; then, computing a delta value of the two C/No measurements (e.g., the C/No measurement of the untracked signal and the C/No measurement of the tracked signal); storing the delta value as a calibration measurement; and using the calibration measurement later to derive or approximate the C/No of the untracked signal based on the C/No measurement of the tracked signal later on (e.g., after a given time period or a given time threshold).

In some embodiments, a third method (referred to herein as “Method 3: Peak-Value Derivation”) may provide for cross-correlation detection based on using additional hardware (HW) circuitry (e.g., correlators and a small number of code taps) inside a channel hardware of the receiver 105 to sample the second signal. As used herein, “to sample” an untracked signal refers to determining a measurement (e.g., determining a value) based on receiving a portion (e.g., making a snapshot measurement) of a signal that is an untracked signal. For example, the method may include using a tracked signal's frequency and code phase measurements to derive an untracked signal's frequency and code phase; and then, at the derived frequency and code phase, measuring the untracked signal's C/No. In such embodiments, a receiver may not track the untracked signal's frequency and code phase. Instead, the receiver may make a snapshot measurement of the untracked signal's C/No (e.g., based on the derived frequency and code phase).

### Method 1: Constant-Value Derivation

FIG. 3A and 3B (collectively, FIG. 3) are block diagrams depicting a first method for cross-correlation detection, according to some embodiments of the present disclosure.

Referring to FIG. 3A, in some embodiments, the receiver 105 may select a first signal s1, which is associated with BIC, to be a tracked signal. The receiver 105 may select a second signal s2, which is associated with B1I, to be an untracked signal. The receiver 105 may determine (e.g., may generate) a first measurement M1 from the first signal s1 based on tracking the first signal s1 at a first time t1. The first measurement M1 may be a C/No ratio associated with the first signal s1.

Referring to FIG. 3B, at a second time t2, the receiver 105 may determine (e.g., may generate) a second measurement M2 associated with the second signal s2 based on the first measurement M1. Determining a second measurement M2 based on a first measurement M1, as used herein, refers to estimating, deriving, or indirectly measuring the second measurement M2 based on the first measurement M1. For example, the second measurement M2 may be a C/No ratio associated with the second signal s2. In some embodiments, the receiver 105 may calculate the second measurement M2 based on an equation EQ and based on a constant value K. For example, the constant value K may be a value that is stored on the receiver 105 based on a standard (e.g., based on an Interface Control Document (ICD)). The ICD is a standard document that specifies signal levels for each PRN code signal. The equation EQ may provide a relationship between the first measurement MI and the second measurement M2. For example, the constant value K may be a C/No ratio delta (e.g., may be a power delta value) between the first signal s1 and the second signal s2. The equation EQ may include adding the C/No ratio delta to the first measurement M1 of the first signal s1 to determine the second measurement M2 of the second signal s2.

In some embodiments, a Doppler of the untracked signal (B1I) may be derived based on the following equation: B1I Doppler =BIC Doppler/1575.42*1561.098.

In some embodiments, a C/No of the untracked signal (B1I) may be derived based on the ICD. For example, a B1C minimal received power (also referred to as “B1C power”) may be −159 decibel watts (dBW) for medium Earth orbit (MEO) and −161 dBW for inclined gcosynchronous orbit (IGSO), and B1I minimal received power may be −163 dBW. B1C power here refers to the total signal power (e.g., pilot+data). For MEO: (B1I C/No)=(B1C Total signal C/No)−4 dB. For IGSO: (B1I C/No)=(B1C Total signal C/No)−2 dB. B1C may have two signal components: a pilot component and a data component. The power levels (in dBW) in the ICD refer to the sum of a pilot component power and a data component power.

For a tracker design where only a B1C pilot or a B1C data component is tracked, (B1C/L1C Total C/No)=(data C/No)+6.0 dB, when a strong SV data component is acquired (e.g., tracked). (B1C/L1C Total C/No)=(pilot C/No)+1.8 dB, when a strong SV pilot component is acquired (e.g., tracked).

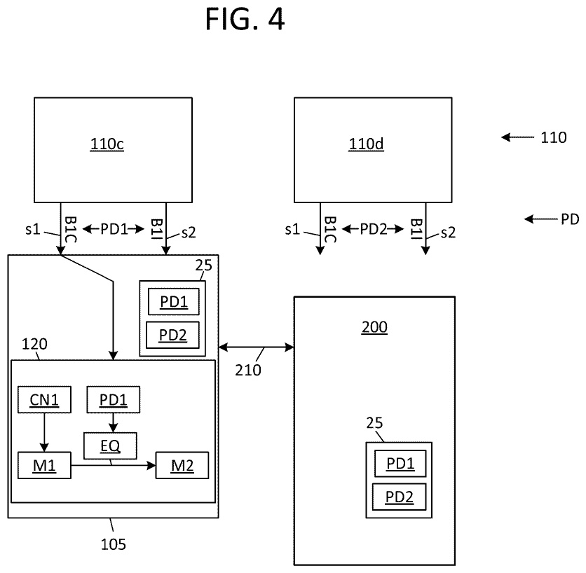

FIG. 4 is a block diagram depicting a modification to the first method for cross-correlation detection, according to some embodiments of the present disclosure.

Referring to FIG. 4, in some embodiments, a power delta (e.g., a difference) between B1I and B1C received at the receiver 105 may be due to the transmitted power delta at the satellites 110. The power-delta value may be different for different satellites. For example, satellite 110c may have a first power-delta value PD1, and satellite 110d may have a second power-delta value PD2. In some embodiments, the power-delta values PD for each satellite 110 may be measured by the receiver 105 or by an assisting node 200 (e.g., a reference GNSS receiver or a server) in an open-sky stationary condition, which may allow a set 25 of power-delta values PD for all the satellites 110 (e.g., PRN numbers from 19 to 46) to be generated. The set 25 of power-delta values PD may then be programmed into some of (e.g., into all of) the GNSS receivers for use with the equation EQ in deriving measurements of the second signal s2 from measurements of the first signal s1. For example, a given power-delta value PD may replace the constant values K (e.g., replacing the ICD values) discussed above with reference to FIG. 3B.

In some embodiments, the receiver 105 may perform a measurement (e.g., a one-time measurement) of transmitted power-delta values PD for the satellites 110 and store the power-delta values PD for future use.

In some embodiments, the assisting node 200 (e.g., a reference GNSS receiver or server) may monitor the first signal s1 (e.g., B1I) and the second signal s2 (e.g., B1C) and transmit the power-delta values PD periodically. In some embodiments, the power-delta values PD may be updated and stored in the assisting node 200 on a regular basis. For example, the assisting node 200 may be an assisted-GNSS (A-GNSS) server). In some embodiments, the power-delta values PD may be provided as part of GNSS aiding data from the A-GNSS server. In some embodiments, each GNSS receiver (e.g., the receiver 105) may download updated power-delta values PD from the A-GNSS server on a regular basis (e.g., periodically).

In some embodiments, where B1I instead of B1C is tracked for the same PRN number, B1C may be derived similarly based on B1I measurements for the same PRN.

### Method 2: Calibration-Value Derivation

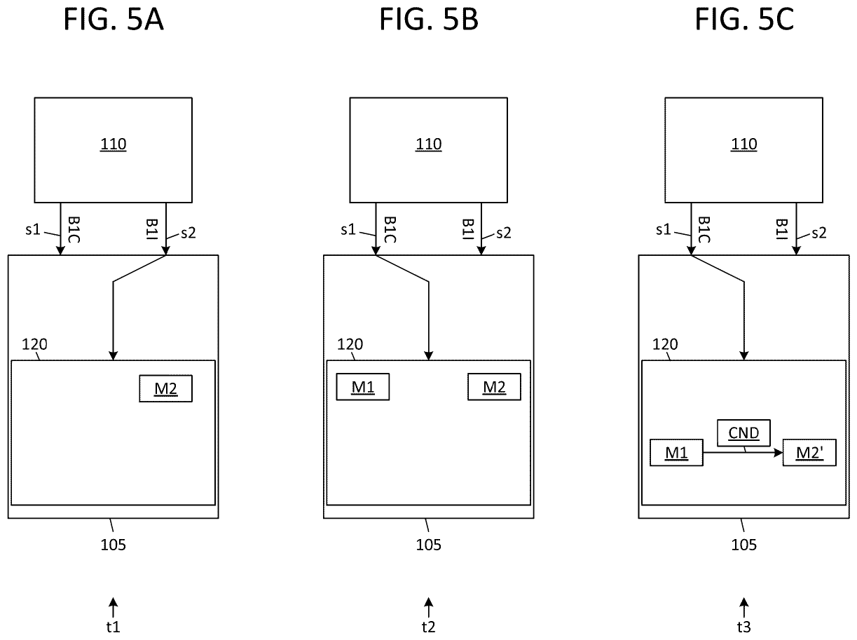

FIGS. 5A-5C (collectively, FIG. 5) are block diagrams depicting a second method for cross-correlation detection, according to some embodiments of the present disclosure.

In some embodiments, doppler derivation may be the same as discussed above for Method 1. According to Method 2, before starting tracking of any B1C of a PRN code, the receiver 105 may perform tracking of the B1I of the same PRN number for a short period of time to obtain an initial C/No measurement (e.g., a calibration measurement) of the B1I. That is, the receiver 105 may select the B1I to be a tracked signal for a period of time (e.g., for a relatively short period of time) to obtain a calibration measurement of the B1I. Based on obtaining the initial C/No measurement of the B1I, the receiver 105 may start B1C tracking that will output a C/No measurement of the B1C. Because the two measurements (e.g., the initial C/No measurement of the B1I and the C/No measurement of the B1C) are taken close together in time (e.g., within a few seconds), their C/No delta may be considered to be about equal to the C/No delta between the B1I and B1C signals of the PRN code for a period of time (e.g., a predetermined period of time). The period of time may be relatively long (e.g., tens of minutes or a few hours). A C/No delta value CND, determined based on the initial C/No measurement of the B1I and the C/No measurement of the B1C, may be used to derive the B1I C/No from the B1C C/No of the same PRN code that is being tracked. Method 2 may provide for cross-correlation detection without using the constant delta in the derivation equations, as discussed above with respect to Method 1. For example, Method 2 may be applied as a near real-time (e.g., as a real-time) solution using actual power measurements (e.g., using an actual power delta).

Referring to FIG. 5A, in some embodiments, the receiver 105 may select the first signal s1 (e.g., BIC) to be a tracked signal and may select the second signal s2 (e.g., B1I) to be an untracked signal. According to Method 2, the untracked signal may be the signal from which a calibration measurement is taken. For example, at a first time t1, the receiver 105 may track the second signal s2 for a short period of time (e.g., 2 seconds) to obtain a second measurement M2 (e.g., an initial C/No measurement of the B1I) from the second signal s2 and may store the second measurement M2 on the receiver 105. At a second time t2, the receiver may stop tracking the second signal s2 and may begin tracking the first signal s1 (e.g., B1C) to obtain a first measurement MI (e.g., the C/No measurement of the B1C). In some embodiments, the receiver 105 may track the first signal s1 (e.g., the designated tracked signal) for a longer period of time than the second signal s2 (e.g., the designated untracked signal). For example, the untracked signal may be tracked for a few seconds (e.g., 2 seconds), while the tracked signal may be tracked for several minutes (e.g., 10 minutes).

In some embodiments, the receiver 105 may determine a C/No delta value CND based on the first measurement MI and based on the second measurement M2. At a third time t3, the receiver 105 may generate an updated second measurement M2′ (e.g., an updated C/No measurement of the B1I) based on the C/No delta value CND.

### Method 3: Peak-Value Derivation

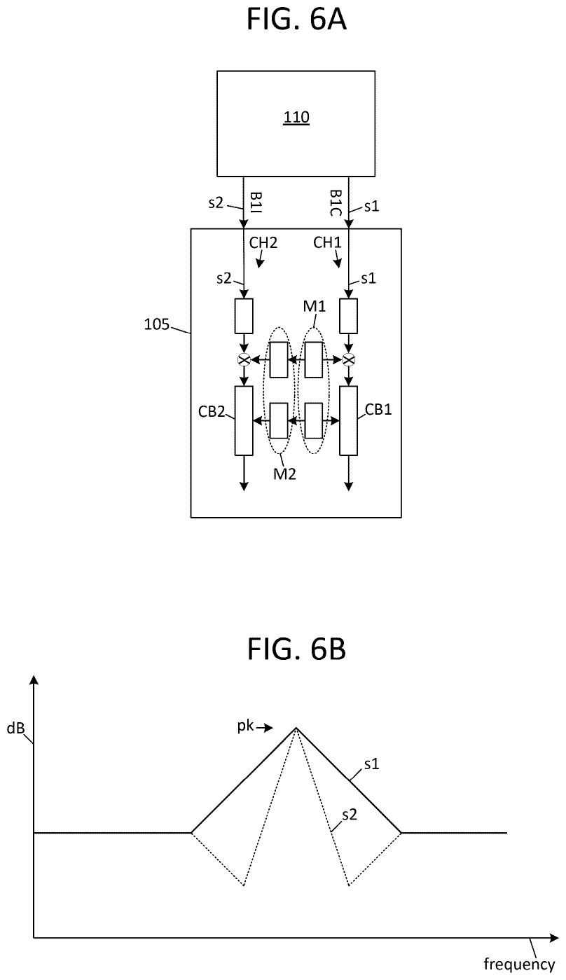

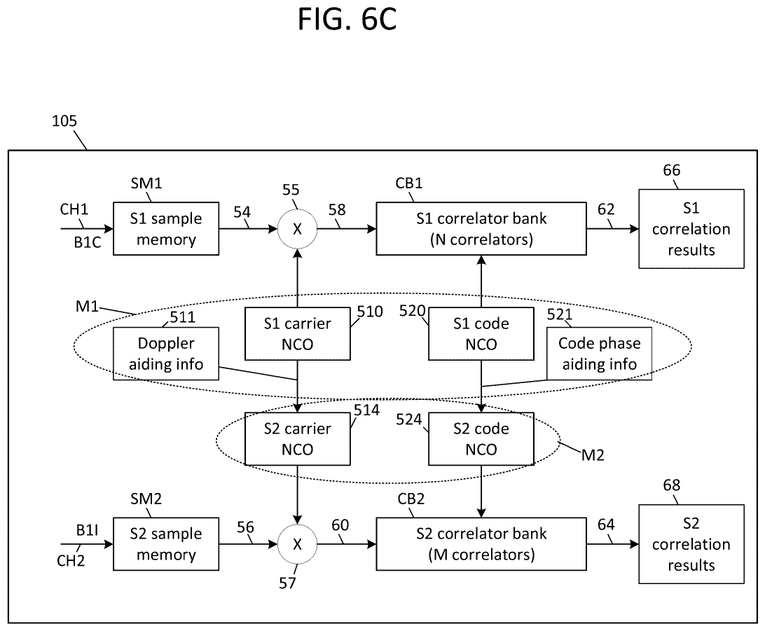

FIG. 6A is a block diagram depicting a third method for cross-correlation detection, according to some embodiments of the present disclosure.

FIG. 6B is a graph depicting a relationship between a peak of a tracked signal and a peak of an untracked signal utilized by the third method, according to some embodiments of the present disclosure.

FIG. 6C is a block diagram depicting components of a receiver for performing the third method, according to some embodiments of the present disclosure.

Referring to FIG. 6A, in some embodiments, according to Method 3, the receiver 105 may implement cross-correlation detection based on two tracking channels (e.g., channel CH1 and channel CH2), wherein one of the tracking channels (e.g., channel CH2), which is configured to sample the untracked signal (e.g., the B1I signal), may be implemented with a simplified hardware design. For example, a first correlator bank CB1 (e.g., associated with channel CH1) for tracking the tracked signal (e.g., the B1C signal) may include more correlators than a second correlator bank CB2 (e.g., associated with channel CH2) for sampling the untracked signal (e.g., the B1I signal).

Method 1 and Method 2, discussed above, may allow for cross-correlation tracking based on one channel (e.g., based on using one full channel) for tracking and deriving signal measurements, while Method 3 may allow for cross-correlation detection using one full channel for tracking the designated tracked signal and using a simplified additional channel for sampling the designated untracked signal and deriving measurements of the designated untracked signal.

Because B1C and B1I signals of the same PRN number are from the same satellite and because the signal-code phase and doppler of the satellite may be predicted accurately by the first correlator bank CB1 (e.g., a bank of correlators used to track B1C, as the designated tracked signal), the additional B1I channel hardware may include a relatively small number of correlators. That is a first measurement MI associated with the first signal s1, and determined based on the full tracking channel CH1, may be used to derive a second measurement M2 associated with the second signal s2, and utilized by the simplified channel CH2.

Referring to FIG. 6A and FIG. 6B, the designated untracked signal channel (e.g., CH2) may be implemented with a smaller number of correlators than the designated tracked signal channel (e.g., CH1) based on the receiver 105 being able to derive B1I information from the B1C signal. For example, because the B1C and the B1I signals having the same PRN code are transmitted from the same satellite 110, both the first signal s1 (e.g., the B1C signal) and the second signal s2 (e.g., the B1I signal) may have peaks pk at the same position (e.g., at a same code phase and frequency). For example, the receiver 105 may determine a location of a peak signal strength of the second signal s2 based on tracking the first signal s1 and determining a signal frequency and a signal code phase of the first signal s1. In the graph of FIG. 6B, the y-axis represents signal strength in dB, and the x-axis represents frequency in Hertz (Hz). For example, because the B1C and the B1I signals are transmitted from the same satellite 110, by using the code phase and frequency measurements corresponding to the peak of the first signal s1 (e.g., the tracked B1C signal), the code phase and frequency corresponding to the peak of the second signal s2 (e.g., the untracked B1I signal) may be derived or estimated. Accordingly, the receiver 105 may sample the second signal s2 (e.g., the designated untracked signal) just long enough to determine the signal strength (e.g., the B1I C/No) of the peak pk of the second signal s2, with remaining tracking information for the second signal s2 being derived from the fully tracked first signal s1.

Referring to FIG. 6C, a B1C signal may be tracked by the receiver 105 using the illustrated components. As discussed above, channel CH1 may be a full tracking channel for tracking the designated tracked signal s1 (e.g., B1C). Channel CH2 may be a simplified tracking channel for sampling the designated untracked signal s2 (e.g., B1I). Channel CH1 may include a first sample memory SM1 to store samples associated with the first signal s1 (e.g., BIC). A first sample-memory output 54 may be provided to a first mixer 55, along with an output from a first carrier numerically controlled oscillator (NCO) 510, for a B1C carrier mix-down operation. A first mixer output 58 may be provided to the first correlator bank CB1, having N correlators. The N correlators may cooperate to perform the tracking (e.g., to assist in performing the tracking) of the first signal (N being an integer greater than one). An output of a first code NCO 520 may be provided to the first correlator bank CB1. A first correlator-bank output 62 may include first correlation results 66. The channel CH1 may be a full tracking channel implemented with several correlators to track the code from the first signal s1 and one or more correlators to track the carrier of the first signal s1.

In some embodiments, an output of the first carrier NCO 510 may be provided to a second carrier NCO 514, associated with the simplified channel CH2, along with Doppler aiding information 511. An output of the first code NCO 520 may be provided to a second code NCO 524, associated with the simplified channel CH2, along with code phase aiding information 521. Because the receiver 105 may derive information (e.g., a second measurement M2) for the second signal s2 based on information (e.g., a first measurement M1) associated with the first carrier NCO 510, the first code NCO 520, the Doppler aiding information 511, and/or the code phase aiding information 521, the receiver 105 may not track a carrier (e.g., a signal carrier frequency) of the second signal s2 and/or may not track a code (e.g., a signal carrier phase) of the second signal s2.

For example, the receiver 105 may implement a method of using a tracked B1C signal to derive an untrack B1I signal (of the same PRN code). The first carrier NCO 510 may be a B1C signal frequency estimate (e.g., a B1C carrier NCO frequency, in units of Hz). The second carrier NCO 514 may be a B1I NCO frequency that is equal to (the B1C carrier NCO frequency)*1561.098/1575.42, in units of Hz.

The first code NCO 520 may be a B1C code NCO code phase (e.g., a B1C signal code phase estimate, with units of B1C chips). The second code NCO 524 (e.g., a B1I code NCO code phase) may be equal to mod (B1C code NCO code phase, 1023)*2+(a constant delay offset between B1C and B1I), with units of B1I chips, wherein mod (.) is the mathematical operation for modulus. For example, mod (2046, 1023)=0 and mod (3679, 1023)=610. The constant delay offset between B1C and B1I is the path delay delta between the B1I and the B1C signal paths. In some embodiments, the constant delay offset between B1C and B1I may be measured, during product development or during a manufacturing process, and stored in the device (e.g., in the receiver 105). The constant delay offset between B1C and B1I generally may not change much (e.g., may not change significantly) during a device's lifetime.

Channel CH2 may include a second sample memory SM2 to store samples associated with the second signal s2 (e.g., B1I). A second sample-memory output 56 may be provided to a second mixer 57, along with an output from the second carrier NCO 514, for a B1I carrier mix-down operation. A second mixer output 60 may be provided to the second correlator bank CB2, having M correlators. The M correlators may cooperate to determine (e.g., to assist in determining) the second measurement M2 (M being an integer greater than zero). An output of the second code NCO 524 may be provided to the second correlator bank CB2. A second correlator-bank output 64 may include second correlation results 68. Because the receiver 105 may only sample the peak signal strength of the second signal s2 (e.g., B1I), a relatively small number of correlators (e.g., one correlator) may be sufficient for deriving measurements for the second signal s2.

In some embodiments, the first carrier NCO 510 and the first code NCO 520, associated with the B1C tracking channel CH1, may send the Doppler aiding information 511 and the code phase aiding information 521 to the second carrier NCO 514 and to the second code NCO 524, associated with the B1I tracking channel CH2. Because B1C and B1I are from the same satellite 110, the aiding information may allow the second correlator bank CB2 (e.g., the bank including B1I correlators) to be implemented with a small number of correlators (e.g., with one to three correlators). For example, the number of B1I correlators (M) in the second correlator bank CB2 may be much smaller than the number of BIC correlators (N) in the first correlator bank CB1. For example, N may equal about 40, while M may equal about 1 or 3. Accordingly, Method 3 may allow the receiver 105 to detect cross-correlation based on fewer hardware components than would be required to perform full tracking on both channels CH1 and CH2. Additionally, Method 3 would allow the receiver 105 to detect cross-correlation while consuming less power than would be consumed by performing full tracking on both channels CH1 and CH2.

FIG. 7 is a block diagram of an electronic device in a network environment, according to some embodiments of the present disclosure.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric clement, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or the server 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

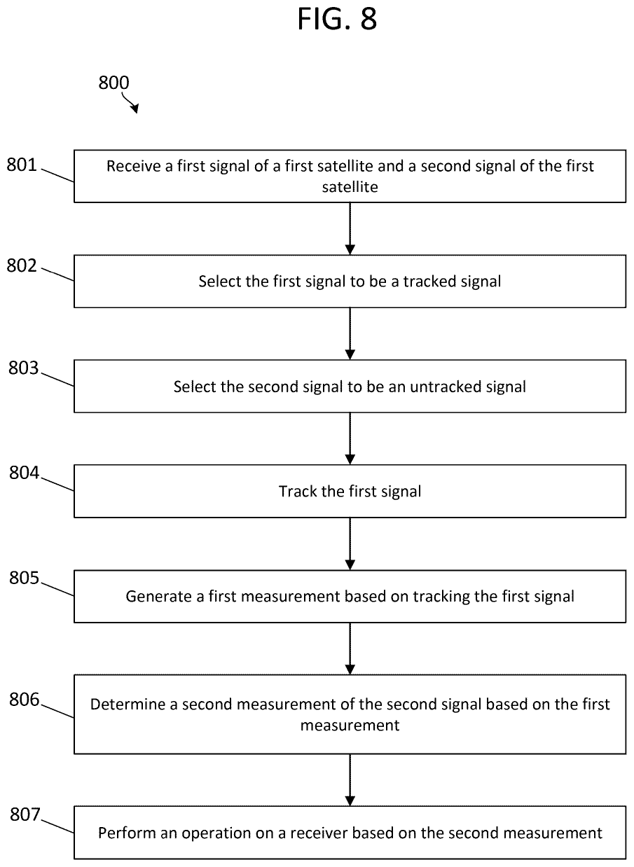

FIG. 8 is a flowchart depicting operations of a method for cross-correlation detection, according to some embodiments of the present disclosure.

Referring to FIG. 8, a method 800 for cross-correlation detection may include one or more of the following operations. A receiver 105 (see, e.g., FIG. 2) may receive a first signal s1 of a first satellite 110c and a second signal s2 of the first satellite 110c (operation 801). The receiver 105 may select the first signal s1 to be a tracked signal (operation 802). The receiver 105 may select the second signal s2 to be an untracked signal (operation 803). The receiver 105 may track the first signal s1 (operation 804). The receiver 105 may generate a first measurement M1 based on the tracking of the first signal s1 (operation 805). The receiver 105 may determine a second measurement M2 (sec, e.g., FIGS. 3B, 4, 5B, 6A, and 6C) of the second signal s2 based on the first measurement M1 of the first signal s1 (operation 806). The receiver 105 may perform an operation on the receiver 105 based on the second measurement M2 (operation 807). For example, the receiver 105 may perform cross-correlation detection and may determine a geographic location based, at least in part, on the second measurement M2. In some embodiments, the geographic location may be input to an application running on a device associated with the receiver 105. For example, to avoid cross-correlation measurements degrading a position accuracy, the receiver 105 may perform cross-correlation detection and may remove the cross-correlation measurements (if any are detected), based, at least in part, on the second measurement M2.

The present disclosure is not limited to the sequence or number of the operations of the method 800 shown in FIG. 8, and can be altered into any desired sequence or number of operations as recognized by a person of ordinary skill in the art. For example, in some embodiments, the order may vary, some processes thereof may be performed concurrently or sequentially, or the method 800 may include fewer or additional operations.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for cross-correlation detection, the method comprising:
receiving, by a receiver, a first signal of a first satellite and a second signal of the first satellite;
selecting, by the receiver, the first signal to be a tracked signal;
selecting, by the receiver, the second signal to be an untracked signal;
tracking, by the receiver, the first signal;
generating, by the receiver, a first measurement based on the tracking of the first signal;
determining, by the receiver, a second measurement of the second signal based on the first measurement; and
performing an operation on the receiver based on the second measurement.

2. The method of claim 1, wherein:
the tracking the first signal comprises tracking, by the receiver, a carrier of the first signal and tracking, by the receiver, a code of the tracked signal; and
being untracked comprises not tracking, by the receiver, a carrier of the untracked signal and/or not tracking, by the receiver, a code of the untracked signal.

3. The method of claim 2, wherein the carrier includes at least one of a signal carrier frequency or a signal carrier phase.

4. The method of claim 1, wherein the operation comprises determining that the second signal is a cross-correlation source associated with a detection associated with a second satellite.

5. The method of claim 1, wherein the operation comprises determining, by the receiver, a geographic location of the receiver.

6. The method of claim 1, wherein the determining the second measurement comprises calculating a result of an equation comprising the first measurement and a constant value.

7. The method of claim 6, wherein the constant value comprises a first power delta value measured with respect to the first satellite.

8. The method of claim 7, wherein the first power delta value is received from a memory of the receiver, the memory storing the first power delta value and storing a second power delta value measured with respect to a second satellite.

9. The method of claim 7, wherein the first power delta value is received from a server that is communicatively coupled to the receiver.

10. The method of claim 1, wherein the determining the second measurement comprises:
selecting the second signal to be a tracked signal;
performing tracking on the second signal and determining a calibration measurement associated with the second signal; and
determining the second measurement based on the first measurement of the first signal and based on the calibration measurement.

11. The method of claim 1, wherein the determining the second measurement comprises:
receiving a sample corresponding to the second signal; and
determining a location of a peak signal strength of the second signal based on the tracking the first signal, the location being associated with a signal frequency and a signal code phase of the first signal.

12. The method of claim 11, wherein:
N correlators cooperate to perform the tracking the first signal, N being an integer greater than one;
M correlators cooperate to perform the determining the second measurement, M being an integer greater than zero; and
N is greater than M.

13. The method of claim 1, further comprising receiving, by a receiver, a third signal of a second satellite and a fourth signal of the second satellite; and either:
selecting, by the receiver, both the third signal and the fourth signal to be tracked signals; or
tracking the third signal and the fourth signal in a time-sharing fashion.

14. A device comprising:
a processing circuit; and
a receiver communicatively coupled to the processing circuit, wherein the receiver is configured to perform:
receiving a first signal of a first satellite and a second signal of the first satellite;
selecting the first signal to be a tracked signal;
selecting the second signal to be an untracked signal;
tracking the first signal;
generating a first measurement based on the tracking of the first signal;
determining a second measurement of the second signal based on the first measurement; and
an operation based on the second measurement.

15. The device of claim 14, wherein the determining the second measurement comprises calculating a result of an equation comprising the first measurement and a constant value.

16. The device of claim 15, wherein the constant value comprises a first power delta value measured with respect to the first satellite.

17. The device of claim 14, wherein the determining the second measurement comprises:
selecting the second signal to be a tracked signal;
performing tracking on the second signal and determining a calibration measurement associated with the second signal; and
determining the second measurement based on the first measurement of the first signal and based on the calibration measurement.

18. The device of claim 14, wherein the determining the second measurement comprises:
receiving a sample corresponding to the second signal; and
determining a location of a peak signal strength of the second signal based on the tracking the first signal, the location being associated with a signal frequency and a signal code phase of the first signal.

19. The device of claim 18, wherein:
N correlators cooperate to perform the tracking the first signal, N being an integer greater than one;
M correlators cooperate to perform the determining the second measurement, M being an integer greater than zero; and
N is greater than M.

20. A system comprising:
a processing circuit; and
a memory storing instructions that, when executed by the processing circuit, cause the processing circuit to perform:
receiving a first signal of a first satellite and a second signal of the first satellite;
selecting the first signal to be a tracked signal;
selecting the second signal to be an untracked signal;
tracking the first signal;
generating a first measurement based on the tracking of the first signal;
determining a second measurement of the second signal based on the first measurement; and
an operation based on the second measurement.
